(19) United States
(12) Patent Application Publication
(10) Pub. No.: US 2024/0374453 A1
(43) Pub. Date: Nov. 14, 2024

(54) FOUR-DEGREE-OF-FREEDOM PARALLEL ROBOT FOR POSTOPERATIVE REHABILITATION OF ANKLE JOINT FRACTURE

(71) Applicant: TIANJIN UNIVERSITY, Tianjin (CN)

(72) Inventors: Tao SUN, Tianjin (CN); Monan NI, Tianjin (CN); Xinming HUO, Tianjin (CN); Yimin SONG, Tianjin (CN)

(21) Appl. No.: 18/685,866

(22) PCT Filed: Apr. 12, 2022
(86) PCT No.: PCT/CN2022/086346

§ 371 Date: Feb. 22, 2024

(30) Foreign Application Priority Data
Feb. 8, 2022 (CN) 202210118196.9
Mar. 31, 2022 (CN) 202210331302.1

(51) Int. Cl. A61H 1/02

(52) U.S. Cl. CPC A61H 1/0266; A61H 2201/0192; A61H 2201/164; A61H 2201/1659; A61H 2201/1671

(57) ABSTRACT

The disclosure for a four-degree-of-freedom parallel robot for postoperative rehabilitation of ankle joint fracture, includes a base, a rotary platform, a pedal adjusting device, a foot pedal and a detachable branched chain; the base and the rotary platform are rotationally connected through bearings to form a revolute pair, and the rotary platform is driven by a driver fixed to the base; three drive branched chains with the same structures are evenly distributed between the rotary platform and the pedal adjusting device; the pedal adjusting device is fixedly connected with the foot pedal. On the basis of the present disclosure, an anatomic model better matching with a physiological structure of an ankle joint complex replaces an oversimplified spherical hinge model, the two axes that do not intersect spatially can rotate and be switched with each other, and therefore the present disclosure meets the requirements of ankle fracture rehabilitation training.

### CROSS-REFERENCE TO RELATED APPLICATIONS

This Application is a national stage application of PCT/CN2022/086346. This application claims priorities from PCT Application No. PCT/CN2022/086346, filed Apr. 12, 2022, and from the Chinese patent applications 2022101181969 filed Feb. 8, 2022, and 2022103313021 filed Mar. 31, 2022, the content of which are incorporated herein in the entirety by reference.

### TECHNICAL FIELD

The present disclosure relates to the field of ankle fracture rehabilitation, in particular to a four-degree-of-freedom parallel robot for postoperative rehabilitation of ankle joint fracture.

### BACKGROUND ART

Ankle joint fracture has been the focus and difficulty in the orthopaedical field of China because of its multiple fracture inducements, complex fracture situations and high morbidity. At present, most postoperative rehabilitation methods are self-rehabilitation training at home according to the doctor's advice. Permanent complications and even secondary injuries are easily caused due to improper rehabilitation. Due to the adoption of an ankle joint rehabilitation robot assisting in patient's rehabilitation training, long-term, repetitive and targeted training can be achieved, thereby achieving better rehabilitation effects.

Most ankle joint rehabilitation robots designed and researched currently adopt parallel mechanisms, for the reasons that the parallel mechanisms have the characteristic of inherent high stiffness and conform to motion characteristics of ankle joints. For example, CN105105970A disclosed a flexibly-driven ankle joint rehabilitation robot, an ankle joint is simplified into a spherical hinge, the motion capacity of the ankle joint in three DOFs is achieved. However, this robot is not high in control precision and hardly suitable for rehabilitation training of fracture patients with limited postoperative motion capacities and motion precision requirements. CN110840707A disclosed an ankle joint rehabilitation robot, including two unconstrained drive branched chains and a two-rotation exactly-constrained branched chain. Similarly, the ankle joint is simplified into the spherical hinge, and two DOFs commonly used for rehabilitation training are provided. The robot has the advantages of simple structure and high control precision. However, an ankle joint complex is complex in structure, and possibly achieves rehabilitation of nerve injuries such as strokes (cerebral apoplexy) when simplified into the spherical hinge, but is oversimplified for rehabilitation training for ankle fractures where an ankle body structure is damaged.

### SUMMARY

The present disclosure aims at providing a four-degree-of-freedom parallel robot for ankle fracture postoperative rehabilitation, which conforms to a rehabilitation training capacity of the ankle joint, and better conforms to a physiological structure of an ankle joint. The present disclosure is achieved through the following technical solutions:

A rehabilitation robot for ankle joint fracture according to the present disclosure, includes a base, a rotary platform, a pedal adjusting device, a foot pedal and a detachable branched chain. The base and the rotary platform are rotationally connected through bearings to form a revolute pair, and the rotary platform is driven by a driver fixed to the base. Three drive branched chains with the same topological structures and slightly different sizes are evenly distributed between the rotary platformrotary platform and the pedal adjusting device. The pedal adjusting device is fixedly connected with the foot pedal. Mounting holes are reserved in the rotary platform and the pedal adjusting device respectively for mounting/detaching the detachable branched chain.

Each drive branched chain includes a drive rod, an arc-shaped connecting rod and a Hooke hinge. One end of the drive rod is rotationally connected with a rotary platform to form a revolute pair, the other end of the drive rod is rotationally connected with one end of the arc-shaped connecting rod to form a revolute pair, the other end of the arc-shaped connecting rod is fixedly connected with one end of the Hooke hinge through two bolts, a pin shaft at the other end of the Hooke hinge is rotationally connected with the pedal adjusting device through bearings to form a revolute pair, the Hooke hinge has a cross shaft structure, and two rotation DOFs exist between the two ends of the Hooke hinge.

The pedal adjusting device includes a sliding platform and three sliding rails with the same structures, three sliding branches on the sliding platform are fixedly connected with the three sliding rails respectively, a sliding block of each sliding rail is provided with a locking mechanism, and the sliding rail can be locked by the locking mechanism. The three sliding blocks with the same structures are connected with the three drive branched chains respectively.

The foot pedal includes a pedal, a backing plate and a six-dimensional force sensor. The pedal is fixedly connected with the sliding platform through the six-dimensional force sensor, the backing plate is connected with the pedal through two pairs of studs and butterfly nuts, and the backing plate can move in a sliding groove of the pedal and is locked by the butterfly nuts for adjusting a treading position of a foot.

The detachable branched chain includes a shaft sleeve and a sliding rod, the shaft sleeve and the sliding rod form a moving pair, and a locking mechanism is arranged on the shaft sleeve, which can lock the moving pair. The detachable adjusting branched chain is in a detached state when rehabilitation training is carried out. When performing pedal adjustment for the pedal adjusting device, the detachable branched chain is mounted to participate in adjustment, and during mounting, the shaft sleeve is fixedly connected with the rotary platform, and the sliding rod is fixedly connected with the foot pedal.

An application method of the rehabilitation robot for ankle joint fractures, includes the following steps:
before rehabilitation training, mounting the detachable branched chain and then locking it, putting the foot of a patient on the foot pedal, adjusting the backing plate to make a center of the ankle joint coincide with a center of rotation of the rotary platform, and locking the backing plate; releasing the sliding rails of the pedal adjusting device, adjusting a center of motion of the mechanism to coincide with an talocrural joint axis, locking the sliding rails of the pedal adjusting device, and detaching the detachable branched chain;
planning the robot to carry out dorsiflexion/plantarflexion rehabilitation training around an talocrural joint axis till the ankle joint can reach a healthy motion range;
mounting the detachable branched chain and then locking it, releasing the sliding rails of the pedal adjusting device, adjusting the center of motion of the mechanism to coincide with a subtalar joint axis, locking the sliding rails of the pedal adjusting device, and detaching the detachable branched chain; and
planning the robot to carry out inversion/eversion rehabilitation training around the subtalar joint axis till the ankle joint can reach the healthy motion range.

The present disclosure has the beneficial effects: on the basis of following the design principle of bio-compatibility of the ankle joint rehabilitation robot during design, an anatomic model better matching with a physiological structure of an ankle joint complex replaces an oversimplified spherical hinge model, the two axes that do not intersect spatially can rotate and be switched with each other, and therefore the present disclosure meets the requirements of ankle fracture rehabilitation training. In addition, the proposed rehabilitation robot has the advantages of simple mechanism and kinematics description compared with other rehabilitation robots adopting non-spherical hinge models, and can acquire human-computer interaction force in real time in a rehabilitation process, which has great significance for its clinical application at a later stage.

### BRIEF DESCRIPTION OF THE DRAWINGS

FIG. 1 is a schematic diagram of an ankle joint complex model adopted by the present disclosure;

FIG. 2 is a schematic structural diagram of a body of a four-degree-of-freedom parallel robot for postoperative rehabilitation of ankle joint fracture according to the present disclosure;

FIG. 3 is a schematic structural diagram of one drive branched chain of the rehabilitation robot shown in FIG. 2;

FIG. 4 is a schematic structural diagram of a pedal adjusting device of the rehabilitation robot shown in FIG. 2;

FIG. 5 is a schematic structural diagram of a foot pedal of the rehabilitation robot shown in FIG. 2; and

FIG. 6 is a schematic structural diagram of a detachable branched chain of the rehabilitation robot shown in FIG. 2.

### DETAILED DESCRIPTION OF THE PRESENT DISCLOSURE

The specific implementations of the present disclosure will be described in detail below with reference to the drawings.

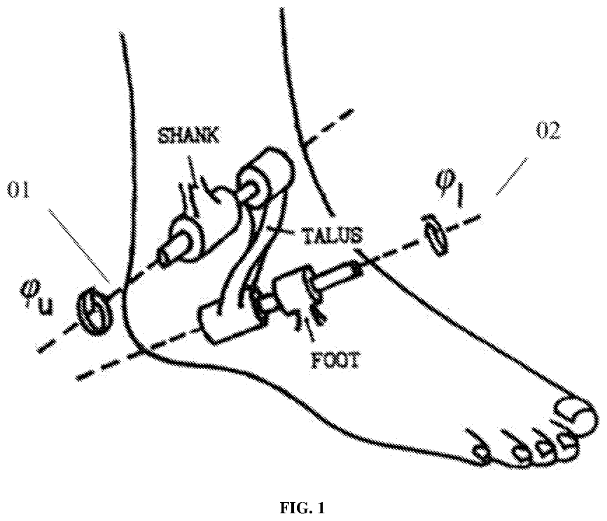

FIG. 1 shows a schematic diagram of a physiological structure of an ankle joint complex followed by a four-degree-of-freedom parallel robot for postoperative rehabilitation of ankle joint fracture according to the present disclosure. The ankle joint complex includes an ankle joint and a subtalar joint, both of them jointly complete rotation of the ankle joint in three directions, namely dorsiflexion/plantarflexion, inversion/eversion and intorsion/extorsion motion. Ankle fracture postoperative rehabilitation training mainly includes dorsiflexion/plantarflexion training around a talocrural joint axis 01 and inversion/eversion training around a subtalar joint axis 02 in the mid to late of rehabilitation. The talocrural joint axis 01 and the subtalar joint axis 02 are straight lines that do not intersect spatially, and position and posture information thereof can be obtained from a large quantity of anatomy experiments that have been published. Thus, the rehabilitation robot is structurally designed to be able to achieve all freedom degrees including the ankle joint complex.

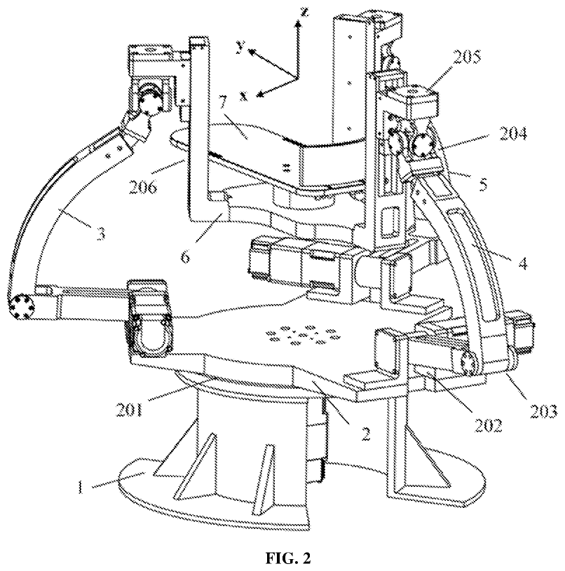

FIG. 2 is a schematic structural diagram of a four-degree-of-freedom parallel robot for postoperative rehabilitation of ankle joint fracture according to the present disclosure. The body includes a base 1, a rotary platform 2, a pedal adjusting device 6 and a foot pedal 7. Three drive branched chains 3, 4, 5 with the same topological structures and slightly different sizes are evenly distributed between the rotary platform 2 and the pedal adjusting device 7. The pedal adjusting device 6 is fixedly connected with the foot pedal 7. The rotary platform 2 and the base 1 form a revolute pair 201 through bearings, and the rotary platform is driven by a driver fixed to the base 1.

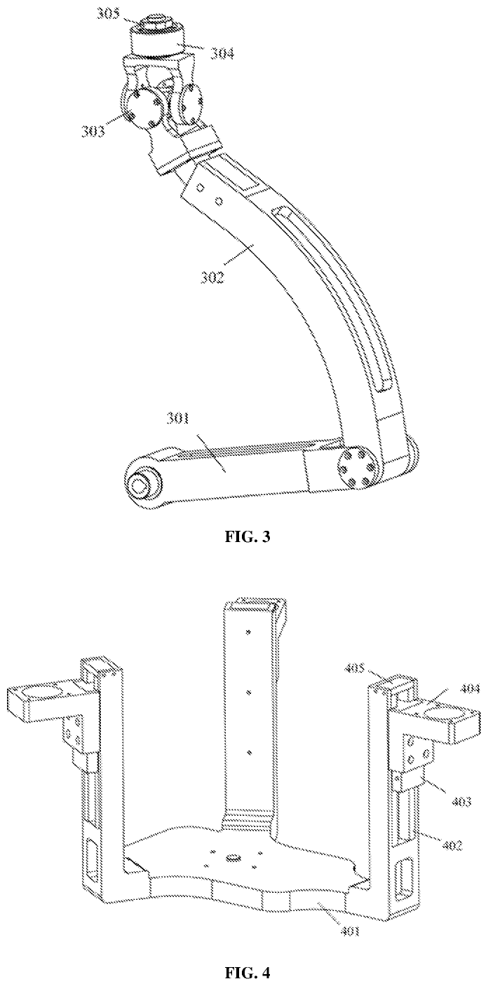

A schematic structural diagram of one drive branched chain 4 is shown in FIG. 3. One end of a drive rod 301 is connected with the rotary platform 2 to form a revolute pair 202 and driven by a driver fixed to the rotary platform 2, and the other end of the drive rod 301 is connected with one end of an arc-shaped connecting rod 302 to form a revolute pair 203. The other end of the arc-shaped connecting rod 302 is fixedly connected with one end of a Hooke hinge 303 through two pairs of screws and nuts. A pin shaft at the other end of the Hooke hinge 303 is connected with a bearing 304 and fixed by a locking nut 305 of the drive branched chain. The Hooke hinge 303 has a cross shaft structure, and two rotation freedom degrees exist between the two ends of the Hooke hinge. The bearing 304 is connected with the pedal adjusting device 6 to form a revolute pair 205. The Hooke hinge 303 and the revolute pair 205 are combined into a spherical pair.

A schematic structural diagram of the pedal adjusting device 6 is shown in FIG. 4. A sliding platform 401 is fixedly connected with three sliding rails 402 with the same structures, a lockable sliding block 403 is connected to each sliding rail to form a moving pair 206, and the moving pair 206 can be locked or released by adjusting the lockable sliding block 403. The lockable sliding blocks 403 are fixedly connected with branched chain connectors 404. The branched chain connectors 404 are connected with the bearings 304 of the drive branched chains 3, 4,5 respectively. Three limiting blocks 405 are fixed to tops of three branches of the sliding platform 401 respectively and used for limiting journeys of the sliding blocks 403.

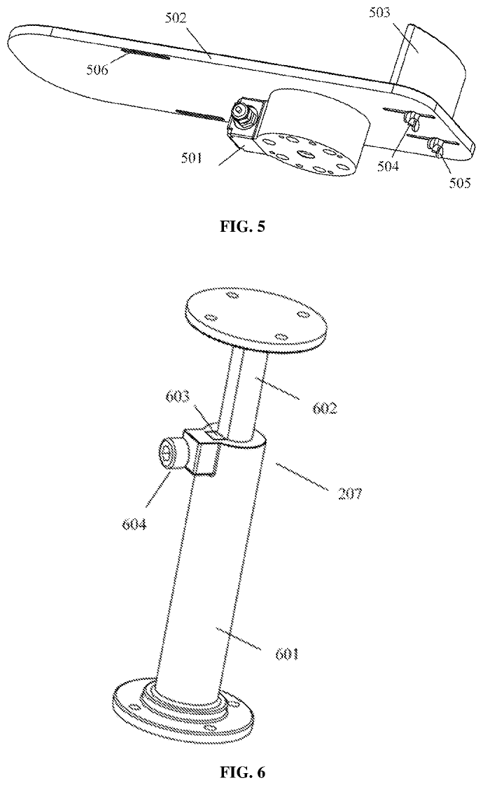

A schematic structural diagram of the foot pedal 7 is shown in FIG. 5. A bottom surface of a six-dimensional force sensor 501 is fixedly connected with the sliding platform 401, and the other surface of the six-dimensional force sensor is fixedly connected with a pedal 502. The pedal 502 is connected with a backing plate 503 through two pairs of studs 504 and butterfly nuts 505. The backing plate can move in a sliding groove of the pedal 502 and can be locked by the butterfly nuts 505 to be used for adjusting a treading position of a patient. Two bandage grooves 506 are formed in a front end of the pedal 502 and used for enabling a foot of the patient to be fixed to the pedal 502 through a bandage.

A detachable branched chain is shown in FIG. 6. The detachable branched chain includes a shaft sleeve 601, a sliding rod 602, a locking block 603 and a locking screw 604. The shaft sleeve 601 and the sliding rod 602 form a moving pair 207, the locking sliding block 603 can be pushed to make contact with the sliding rod 602 by rotating the locking screw 604 if necessary, and the moving pair is locked with the help of friction force. When rehabilitation training is carried out, the detachable adjusting branched chain is detached. When performing pedal adjustment for the pedal adjusting device, the detachable branched chain is mounted to participate in adjustment, and during mounting, the shaft sleeve 601 is fixedly connected with the rotary platform 2, and the sliding rod 602 is fixedly connected with the sliding platform 401.

A movable platform (foot pedal 7) of the four-degree-of-freedom parallel robot for ankle fracture postoperative rehabilitation according to the present disclosure can spatially move along an axis z shown in FIG. 2 and rotate around axes x, y and z. When ankle fracture postoperative rehabilitation training is carried out, three rotation freedom degrees can fit rotation around any axis in space, so as to simulate dorsiflexion/plantarflexion training around the talocrural joint axis 01 and inversion/eversion training around the subtalar joint axis 02 shown in FIG. 1. Switching of the talocrural joint axis 01 and the subtalar joint axis 02 is achieved by combining the detachable branched chain and the pedal adjusting device. The present disclosure has the advantages of simple mechanism and kinematics description compared with other rehabilitation robots adopting non-spherical hinge models, which is conducive to subsequent control and clinical application. In addition, the proposed rehabilitation robot has the function of acquiring human-computer interaction force/torque in real time, so as to carry out further main power control.

An application method of the above four-degree-of-freedom parallel robot for postoperative rehabilitation of an ankle joint fracture, includes the following steps:
before rehabilitation training, the detachable branched chain is mounted, and the moving pair 207 is locked by rotating the locking screw 604; a foot of the patient is put on the foot pedal 7, the backing plate 503 is adjusted to make a center of the ankle joint coincide with a center of rotation of the rotary platform 2, the butterfly nuts are adjusted to lock the backing plate 503, the lockable sliding blocks 403 are adjusted to release the moving pairs 206, a drive motor adjusts a center of motion of the mechanism to coincide with the talocrural joint axis 01, then the moving pair 206 is locked, the moving pair 207 is released, and the detachable branched chain is detached;
when rehabilitation training is carried out, the robot is planned to carry out dorsiflexion/plantarflexion rehabilitation training around the talocrural joint axis 01 till the ankle joint can reach a healthy motion range;
the motion axes are switched: the detachable branched chain is mounted, the moving pair 207 is locked, the moving pairs 206 are released, the drive motor adjusts the center of motion of the mechanism to coincide with the subtalar joint axis 02, then the moving pairs 206 are locked, the moving pair 207 is released, and the detachable branched chain is detached; and
the robot is planned to carry out inversion/eversion rehabilitation training around the subtalar joint axis 02 till the ankle joint can reach the healthy motion range.

The above description of the present disclosure is merely schematic, instead of restrictive, and thus the implementations of the present disclosure are not limited to the above specific implementations. Similarly, under the inspiration of the mechanical structure of the present disclosure, other changes of kinematic pair layout or modifications of the mechanical structure made without departing from the purpose of the present disclosure and the scope of protection of the claims all fall within the scope of protection of the present disclosure.

What is claimed:

1. A four-degree-of-freedom parallel robot for postoperative rehabilitation of ankle joint fracture, includes a base (1), a rotary platform (2), a pedal adjusting device (6), a foot pedal (7) and a detachable branched chain; the base (1) and the rotary platform (2) are rotationally connected through bearings to form a revolute pair, and the rotary platform (2) is driven by a driver fixed to the base (1); three drive branched chains (3, 4, 5) with the same topological structures and slightly different sizes are evenly distributed between the rotary platform (2) and the pedal adjusting device (6); the pedal adjusting device (6) is fixedly connected with the foot pedal (7); mounting holes are reserved in the rotary platform (2) and the pedal adjusting device (6) respectively for mounting/detaching the detachable branched chain.

2. The four-degree-of-freedom parallel robot for postoperative rehabilitation of ankle joint fracture according to claim 1, wherein each drive branched chain (3, 4, 5) includes a drive rod (301), an arc-shaped connecting rod (302) and a Hooke hinge (303); one end of the drive rod (301) is rotationally connected with a rotary platform 2 to form a revolute pair, the other end of the drive rod (301) is rotationally connected with one end of the arc-shaped connecting rod (302) to form a revolute pair, the other end of the arc-shaped connecting rod (302) is fixedly connected with one end of the Hooke hinge (303) through two bolts, a pin shaft at the other end of the Hooke hinge is rotationally connected with the pedal adjusting device (6) through bearings to form a revolute pair, the Hooke hinge (303) has a cross shaft structure, and two rotation DOFs exist between the two ends of the Hooke hinge.

3. The four-degree-of-freedom parallel robot for postoperative rehabilitation of ankle joint fracture according to claim 1, wherein the pedal adjusting device (6) includes a sliding platform (401) and three sliding rails (402) with the same structures, three sliding branches on the sliding platform are fixedly connected with the three sliding rails (402) respectively, a sliding block (403) of each sliding rail (402) is provided with a locking mechanism, and the sliding rail (402) is capable of being locked by the locking mechanism; the three sliding blocks (403) with the same structures are connected with the three drive branched chains (3, 4, 5) respectively.

4. The four-degree-of-freedom parallel robot for postoperative rehabilitation of ankle joint fracture according to claim 3, wherein the foot pedal (7) includes a pedal (502), a backing plate (503) and a six-dimensional force sensor; the pedal (502) is fixedly connected with the sliding platform (401) through the six-dimensional force sensor, the backing plate (503) is connected with the pedal (502) through two pairs of studs (504) and butterfly nuts (505), and the backing plate (503) is capable of moving in a sliding groove of the pedal (502) and is locked by the butterfly nuts (505) for adjusting a treading position of a foot.

5. The four-degree-of-freedom parallel robot for postoperative rehabilitation of ankle joint fracture according to claim 1, wherein the detachable branched chain includes a shaft sleeve (601) and a sliding rod (602), the shaft sleeve (601) and the sliding rod (602) form a moving pair (207), and a locking mechanism is arranged on the shaft sleeve (601), which is capable of locking the moving pair (207); the detachable adjusting branched chain is in a detached state when rehabilitation training is carried out; when performing pedal adjustment for the pedal adjusting device (6), the detachable branched chain is mounted to participate in adjustment, and during mounting, the shaft sleeve (601) is fixedly connected with the rotary platform (2), and the sliding rod (602) is fixedly connected with the foot pedal (7).

6. An application method of the rehabilitation robot for ankle joint fractures, including:
before rehabilitation training, mounting the detachable branched chain and then locking it, putting the foot of a patient on the foot pedal (7), adjusting the backing plate (503) to make a center of the ankle joint coincide with a center of rotation of the rotary platform (2), and locking the backing plate (503); releasing the sliding rails (402) of the pedal adjusting device (6), adjusting a center of motion of the mechanism to coincide with a talocrural joint axis, locking the sliding rails (402) of the pedal adjusting device (6), and detaching the detachable branched chain;
planning the robot to carry out dorsiflexion/plantarflexion rehabilitation training around an talocrural joint axis (01) till the ankle joint can reach a healthy motion range;
mounting the detachable branched chain and then locking it, releasing the sliding rails (402) of the pedal adjusting device (6), adjusting the center of motion of the mechanism to coincide with a subtalar joint axis (02), locking the sliding rails (402) of the pedal adjusting device (6), and detaching the detachable branched chain; and
planning the robot to carry out inversion/eversion rehabilitation training around the subtalar joint axis (02) till the ankle joint can reach the healthy motion range.
